(19) United States
(12) Patent Application Publication
(10) Pub. No.: US 2022/0367937 A1
(43) Pub. Date: Nov. 17, 2022

(54) HEAT INSULATION SHEET FOR BATTERY PACK, AND BATTERY PACK

(71) Applicant: IBIDEN CO., LTD., Ogaki-shi, Gifu (JP)

(72) Inventors: Hisashi ANDO, lbi-gun, Gifu (JP); Naoki TAKAHASHI, lbi-gun, Gifu (JP)

(73) Assignee: IBIDEN CO., LTD., Ogaki-shi, Gifu (JP)

(21) Appl. No.: 17/761,512

(22) PCT Filed: Aug. 31, 2020
(86) PCT No.: PCT/JP2020/032966

§ 371 Date: Mar. 17, 2022

(30) Foreign Application Priority Data
Sep. 19, 2019 (JP) 2019-170437

(51) Int. Cl. H01M 10/658; H01M 10/6555; H01M 50/204; H01M 50/51; H01M 50/512; F16L 59/02

(52) U.S. Cl. CPC H01M 10/658; H01M 10/6555; H01M 50/204; H01M 50/51; H01M 50/512; F16L 59/028

(57) ABSTRACT

To provide a heat insulation sheet for a battery pack that has a good shape retention property and can maintain an excellent heat insulation property even when vibration or pressure is applied, and a battery pack in which a heat insulation sheet for a battery pack is interposed between battery cells. A heat insulation sheet (10) of the present invention is a heat insulation sheet for a battery pack, the heat insulation sheet being interposed between battery cells in a battery pack in which a plurality of battery cells is connected in series or in parallel. The heat insulation sheet (10) includes: a first heat insulation material (21) containing a silica nanoparticle; and a second heat insulation material (22) containing a plate-shaped particle containing a silica component and having a curved surface.

### TECHNICAL FIELD

The present invention relates to a heat insulation sheet for a battery pack, the heat insulation sheet being interposed between battery cells of the battery pack, and a battery pack in which a heat insulation sheet for a battery pack is interposed between battery cells.

### BACKGROUND ART

In the related art, in order to prevent heat transmission from a heating element to another object, a heat insulation sheet for a battery pack used in close proximity to the heating element or at least partially in contact with the heating element is used.

In recent years, there is an increase in demand for lithium-ion secondary batteries capable of high capacity and high output compared with lead storage batteries, nickel-metal hydride batteries, and the like. The lithium-ion secondary batteries are used not only for small-capacity secondary batteries for mobile phones, personal computers, and small electronic devices, but also for large-capacity secondary batteries for automobiles, backup power supplies, and the like. Especially, in the field of automobiles, development of electric vehicles or hybrid vehicles driven by electric motors is actively promoted from the viewpoint of environmental protection. The electric vehicles, hybrid vehicles, and the like are equipped with a battery pack in which a plurality of battery cells are connected in series or in parallel to serve as a power source for a driving electric motor.

However, the lithium-ion secondary battery may generate heat due to a chemical reaction during charging and discharging, which causes a malfunction of the battery or the like. For example, when a battery cell suddenly rises in temperature and then causes thermal runaway that continues to generate heat, the heat from the battery cell that causes the thermal runaway transmits to other adjacent battery cells, and it may cause thermal runaway of the other battery cells.

In the field of battery pack as described above, in order to prevent heat transmission from the battery cell that caused the thermal runaway to adjacent battery cells and prevent problems such as battery burning and explosion due to a chain of the thermal runaway, various heat insulation materials interposed between the battery cells are proposed. For example, Patent Literature 1 proposes an invention of a heat insulation material using silica aerogel, which has a low heat conductivity (0.02 W/mK) and is an excellent material. In the heat insulation material using only silica aerogel, a bonding force between secondary particles is small and extremely fragile. Therefore, when stress is applied from outside, the silica aerogel is destroyed and properties are deteriorated. In order to compensate for such a defect of silica aerogel, Patent Literature 1 describes a heat insulation material including a composite layer containing a fiber sheet and silica aerogel, in which the fiber sheet is folded and laminated. In a battery unit using the heat insulation material, even when the battery cell repeatedly expands and contracts and a compressive stress is applied to the heat insulation material, the fiber sheet can absorb the stress. As a result, destruction of the silica aerogel can be prevented, and deterioration of a heat insulation property of the silica aerogel can be prevented.

### CITATION LIST

### Patent Literature

Patent Literature 1: JP-A-2018-204708

### SUMMARY OF INVENTION

### Technical Problem

However, even when the above-mentioned heat insulation material is used, when an external force is applied, a layer of the silica aerogel, which is a porous body and fragile, may be destroyed and the heat insulation property thereof may be deteriorated. Especially in applications such as automobiles to which fine vibration is applied, resonance or the like may occur, and the fragile silica aerogel may gradually become finer and fall, resulting in an insufficient heat insulation property of an upper part. Moreover, due to the fall of the silica aerogel, a shape as the heat insulation sheet cannot be maintained for a long period of time.

The present invention is made in view of the above-mentioned situation, and an object of the present invention is to provide a heat insulation sheet for a battery pack that has a good shape retention property and can maintain an excellent heat insulation property even when vibration or pressure is applied, and a battery pack in which the heat insulation sheet for the battery pack is interposed between battery cells.

### Solution to Problem

The above object is achieved by a heat insulation sheet for a battery pack according to the present invention in the following (1).

(1) A heat insulation sheet for a battery pack, the heat insulation sheet being interposed between battery cells in the battery pack in which the battery cells are connected in series or in parallel, the heat insulation sheet including:

a first heat insulation material containing a silica nanoparticle; and

a second heat insulation material containing a plate-shaped particle containing a silica component and having a curved surface.

The heat insulation sheet for the battery pack of the present invention is preferably as the following (2) to (13).

(2) The heat insulation sheet for the battery pack according to (1), in which

the second heat insulation material is oriented in a plane direction.

(3) The heat insulation sheet for the battery pack according to (1) or (2), in which

a content of the first heat insulation material is 10 mass % or more and 60 mass % or less with respect to a total mass of the heat insulation sheet for the battery pack.

(4) The heat insulation sheet for the battery pack according to any one of (1) to (3), in which

the first heat insulation material has an average particle diameter of 1 nm or more and 100 nm or less.

(5) The heat insulation sheet for the battery pack according to any one of (1) to (4), in which

the plate-shaped particle is a fragment of an inorganic balloon.

(6) The heat insulation sheet for the battery pack according to (5), in which

the inorganic balloon is at least one kind of an inorganic balloon selected from a shirasu balloon, a silica balloon, a fly ash balloon, a perlite balloon, and a glass balloon.

(7) The heat insulation sheet for the battery pack according to any one of (1) to (6), in which

the second heat insulation material is the plate-shaped particle having an average particle length of 0.1 μm or more and 100 μm or less.

(8) The heat insulation sheet for the battery pack according to any one of (1) to (7), in which

a content of the second heat insulation material is 10 mass % or more and 60 mass % or less with respect to the total mass of the heat insulation sheet for the battery pack.

(9) The heat insulation sheet for the battery pack according to any one of (1) to (8), further including:

a third heat insulation material containing a metal oxide.

(10) The heat insulation sheet for the battery pack according to (9), in which

the metal oxide is at least one kind of a particle selected from titania, zirconia, zircon, barium titanate, zinc oxide, and alumina.

(11) The heat insulation sheet for the battery pack according to (9) or (10), in which the metal oxide has an average particle diameter of 0.1 μm or more and 50 μm or less.

(12) The heat insulation sheet for the battery pack according to any one of (9) to (11), in which

a content of the third heat insulation material is 5 mass % or more and 40 mass % or less with respect to a total mass of the heat insulation sheet for the battery pack.

(13) The heat insulation sheet for the battery pack according to any one of (1) to (12), further including:

a binding material which contains at least one kind selected from an inorganic fiber, a binder, and a heat resistant resin, in which

a content of the binding material is 10 mass % or more and 60 mass % or less with respect to the total mass of the heat insulation sheet for the battery pack.

The above object is achieved by a battery pack according to the present invention in the following (14).

(14) A battery pack, in which

battery cells are arranged so as to interpose the heat insulation sheet for the battery pack according to any one of (1) to (13), and the battery cells are connected in series or in parallel.

### Advantageous Effects of Invention

The heat insulation sheet for the battery pack of the present invention includes: the first heat insulation material containing the silica nanoparticle; and the second heat insulation material containing the plate-shaped particle containing a silica component and having a curved surface. Since the silica nanoparticle is a fine particle, it has a property of low bulk density and low heat conductivity. The heat insulation sheet for the battery pack of the present invention has a configuration in which the second heat insulation material containing the plate-shaped particle containing a silica component and having a curved surface receives an external pressure to reinforce the heat insulation sheet. Therefore, it is possible to provide a heat insulation sheet for a battery pack that has a good shape retention property and can maintain an excellent heat insulation property even when being compressed due to swelling of batteries and the like, and a battery pack in which the heat insulation sheet for the battery pack is interposed between battery cells.

### BRIEF DESCRIPTION OF DRAWINGS

FIG. 1 is a cross-section schematically showing a heat conduction state in a heat insulation sheet for a battery pack according to a first embodiment of the present invention.

FIG. 2 is an enlarged perspective view schematically showing a part of the heat insulation sheet for the battery pack according to the first embodiment of the present invention.

FIG. 3 is a drawing substitute photograph showing an SEM observation result of the heat insulation sheet for the battery pack according to the first embodiment of the present invention.

FIG. 4 is a schematic diagram showing a second heat insulation material in FIG. 3 more clearly.

FIG. 5 is a cross-section schematically showing an embodiment of a battery pack using the heat insulation sheet for the battery pack shown in FIGS. 1 to 4.

FIG. 6 is a cross-section schematically showing a configuration of a heat insulation sheet for a battery pack according to a second embodiment of the present invention.

### DESCRIPTION OF EMBODIMENTS

In order to provide a heat insulation sheet for a battery pack (hereinafter also referred to as “heat insulation sheet”) that has a good shape retention property and can maintain an excellent heat insulation property even when pressure is applied, inventors of the present application conducted diligent studies. As a result, it is found that the excellent shape retention property and heat insulation property of the heat insulation sheet can be obtained by containing a first heat insulation material containing a silica nanoparticle, and a second heat insulation material containing a plate-shaped particle containing a silica component and having a curved surface, in the heat insulation sheet.

Since the silica nanoparticle contained as the first heat insulation material in the heat insulation sheet is a fine particle and has a large number of contacts, so that the first heat insulation material is a component having an excellent heat insulation property that reduces conductive heat transfer in a wide temperature range.

The inventors of the present application find that when silica nanoparticles having a small average particle diameter are used for the heat insulation sheet, even if the heat insulation sheet is compressed due to swelling of batteries and a density thereof increases, increase in conductive heat transfer of the heat insulation sheet can also be prevented.

It is considered that this is because the silica nanoparticles are insulators, fine voids are likely to be formed between the particles by repulsive force due to static electricity, and the particles are filled so as to have a low bulk density and a cushioning property. That is, when the heat insulation sheet contains silica nanoparticles having an average particle diameter of 1 nm or more and 100 nm or less, even when compressive stress is applied, the voids between the silica nanoparticles and the large number of contacts between the particles reduce conductive heat transfer, and the heat insulation property of the heat insulation sheet can be maintained.

Furthermore, the inventors of the present application find that a size of the voids contained in the heat insulation sheet affects the heat insulation property of the heat insulation sheet. That is, if the voids formed between the particles are, for example, several hundred nm or more, convection and air flow are likely to occur in the voids, and the heat insulation property of the heat insulation sheet may be decreased.

However, in the heat insulation sheet using the silica nanoparticles having a small particle diameter as the first heat insulation material, it is considered that the voids between the particles become as small as several tens of nm, the air flow in the voids is unlikely to occur, generation of convective heat transfer can be prevented, and the heat insulation property can be further improved.

In the present invention, since it is important to form a large number of fine voids and increase the number of contacts between the particles by the silica nanoparticles, the silica nanoparticles may be contained as primary particles or aggregated secondary particles.

A heat insulation sheet using a heat insulation material containing only the first heat insulation material (the silica nanoparticle) may not have a sufficient shape retention property as a sheet since the contacts between the particles are weak. However, in the present invention, since the heat insulation sheet contains the second heat insulation material containing the plate-shaped particle having a curved surface, the excellent shape retention property of the heat insulation sheet can be obtained.

In the present invention, since the plate-shaped particle having a curved surface is used as the second heat insulation material, even when the plurality of the plate-shaped particles are overlapped with each other, the plate-shaped particles are dispersed in the heat insulation sheet in point contact or close to each other while forming appropriate dome-shaped voids. Therefore, the plate-shaped particles have an effect of retaining the silica nanoparticles in the dome-shaped voids and retaining the shape of the entire heat insulation sheet so as not to fall due to vibration or the like.

Furthermore, since the voids are filled with the silica nanoparticles, the air flow can be blocked, the convective heat transfer can be reduced, and the excellent heat insulation property can be obtained.

If the second heat insulation material is simply a flat plate-shaped particle, since the particles adhere to each other in the heat insulation sheet, the heat transmission facilitate. Since it is difficult to form the voids to retain the silica nanoparticles, the shape retention property is reduced, and the silica nanoparticles are likely to fall due to vibration or the like. In the heat insulation sheet of the present invention, since the second heat insulation material has a curved surface, the shape is maintained and the heat insulation property can be obtained.

Moreover, in the present invention, even if battery cells thermally expand and a pressure is applied to the heat insulation sheet, since the second heat insulation material having the dome-shaped voids filled with the first heat insulation material (the silica nanoparticle) resists the pressure while bending, it is possible to prevent the first heat insulation material (the silica nanoparticle) that maintains a heat insulation effect from falling.

The second heat insulation material contain a silica component. Silicon constituting silica is tetravalent, and it is considered that it can be combined with divalent oxygen to form an irregular network structure. Therefore, when silica is melted, it becomes a viscous fluid, and inorganic hollow particles (inorganic balloons) can be easily obtained by a method such as a medium fluidized bed. Using the inorganic hollow particles as a raw material, curved plate-shaped particles containing a silica component can be easily obtained.

<Basic Configuration of Heat Insulation Sheet for Battery Pack>

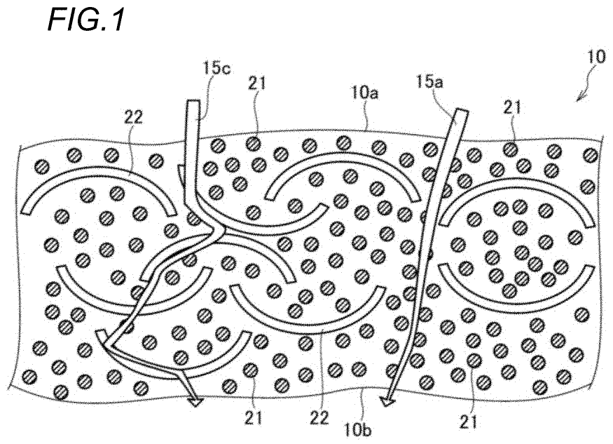

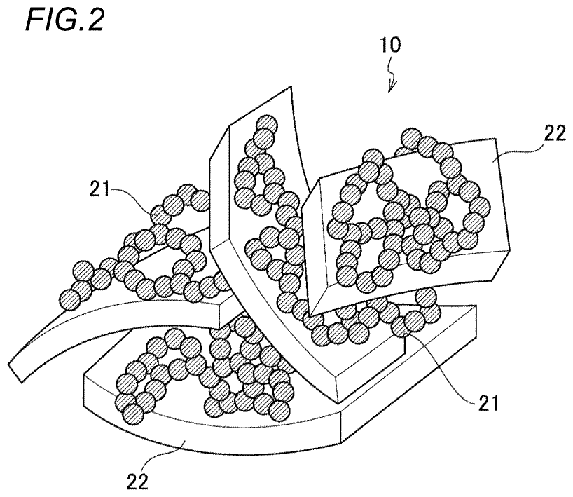

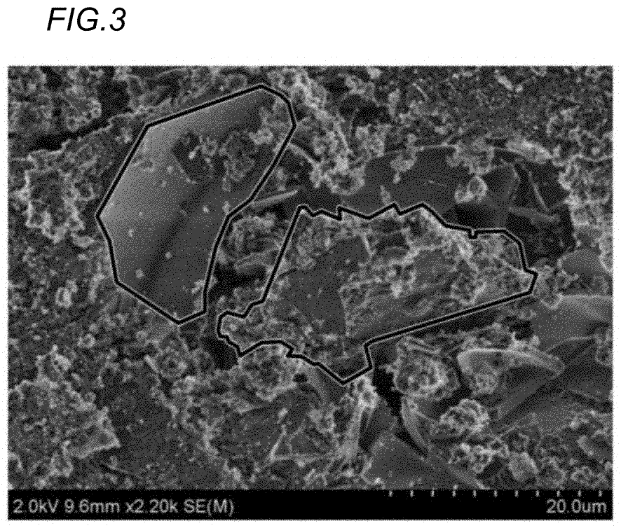

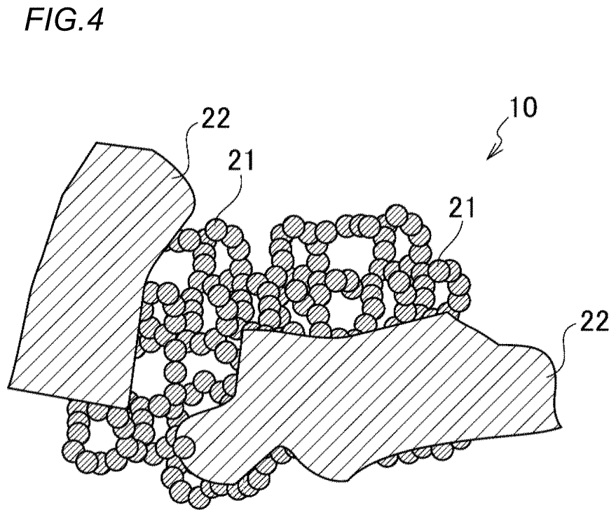

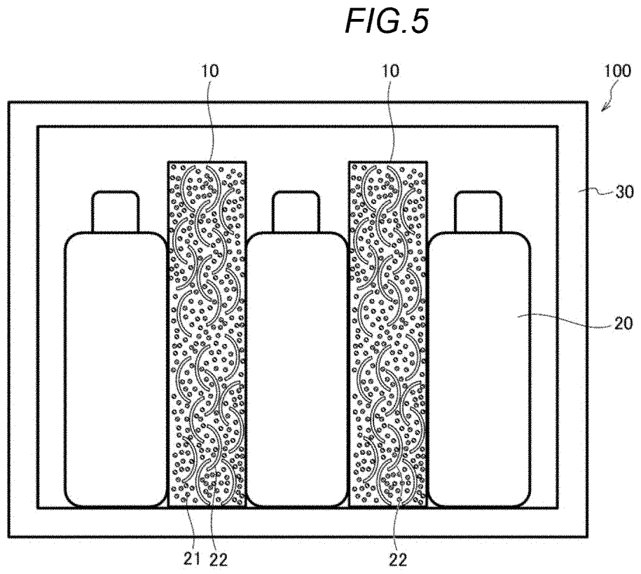

FIG. 1 is a cross-section schematically showing a heat conduction state in a heat insulation sheet for a battery pack according to a first embodiment of the present invention. FIG. 2 is an enlarged perspective view schematically showing a part of the heat insulation sheet for the battery pack according to the first embodiment of the present invention. FIG. 3 is a drawing substitute photograph showing an SEM observation result of the heat insulation sheet for the battery pack according to the first embodiment. FIG. 4 is a schematic diagram showing a second heat insulation material in FIG. 3 more clearly. FIG. 5 is a cross-section schematically showing an embodiment of a battery pack using the heat insulation sheet for the battery pack shown in FIGS. 1 to 4.

As shown in FIGS. 1 to 4, a heat insulation sheet 10 includes a first heat insulation material 21 containing a silica nanoparticle and a second heat insulation material 22 containing a plate-shaped particle containing a silica component and having a curved surface. In FIG. 3, the second heat insulation material 22 is shown by a thick frame. As the first heat insulation material 21, a silica nanoparticle having an average particle diameter of 1 nm or more and 100 nm or less is used. The second heat insulation material 22 is a fragment, which is obtained by applying pressure to and crushing an inorganic balloon having an average particle diameter of 1 μm to 100 μm, and is a plate-shaped particle having an average particle length of 0.1 μm to 100 μm and having a curved surface. A radius of curvature of an outer curved surface of the second heat insulation material is considered to correspond to ½ of the average particle diameter of the inorganic balloon used. A method for measuring the radius of curvature will be described later.

As a specific usage of the heat insulation sheet 10 for battery pack, as shown in FIG. 5, a battery pack 100 is housed in a battery case 30 in a state in which a plurality of battery cells 20 are arranged so as to interpose the heat insulation sheet 10 for the battery pack, and the plurality of battery cells 20 are connected in series or in parallel (the connected state is not shown in the drawing). As the battery cell 20, for example, a lithium ion secondary battery is preferably used, but the battery cell 20 is not particularly limited, and other secondary batteries may also be applied.

In the following description, it is assumed that a heat-generating battery cell 20 exists on one surface 10a side of the heat insulation sheet 10. In the heat insulation sheet configured in this way, when the battery cell 20 generates heat, a part of the incident heat from a side of the surface 10a of the heat insulation sheet 10 is conducted (solid conduction) toward the other surface 10b of the heat insulation sheet 10 as shown by an arrow 15a by mediating the first heat insulation material 21 which is in contact with each other or is adjacent to each other via a binder or the like. In this case, since the silica nanoparticle having a heat insulation property is used as the first heat insulation material 21 and contact points between the particles are small, an amount of heat conducted by the silica nanoparticles is smaller than that when a silica particle having a large particle diameter is used. Therefore, the amount of heat transmitted is reduced as approaching the other surface 10b of the heat insulation sheet 10.

As shown by an arrow 15c, a part of the heat generated by the heat generation of the battery cell 20 may be conducted through the first heat insulation material 21 and the second heat insulation material 22. In the present embodiment, the fragment of the inorganic balloon containing a silica component is used as the second heat insulation material 22, a strength in a plane direction is strengthened, a shape retention property is enhanced, and the same heat insulation property as that of the first heat insulation material 21 is obtained, so that it is difficult to transmit heat in a thickness direction. Therefore, the amount of heat transmitted is reduced as approaching the other surface 10b of the heat insulation sheet 10. Since the second heat insulation material 22 contains the plate-shaped particle having a curved surface, even if the second heat insulation material 22 overlaps each other, an appropriate void portion is formed, and the first heat insulation material having the excellent heat insulation property can be retained in the void portion, and the conduction of heat can be prevented.

Moreover, in the present embodiment, when the battery cells 20 arranged at both sides of the heat insulation sheet 10 thermally expand and a large compressive stress is applied to the heat insulation sheet 10, the second heat insulation material having the dome-shaped voids filled with the first heat insulation material (the silica nanoparticle) resists the stress while bending, and at the same time, it is difficult to apply a large force to the first heat insulation material having an excellent heat insulation effect. Therefore, it is possible to prevent the silica nanoparticles from falling.

Accordingly, according to the present invention, even if a thermal runaway occurs in a certain battery cell 20, since heat transmission to other adjacent battery cells 20 can be effectively prevented, it is possible to prevent the thermal runaway of the other battery cells 20 from being caused.

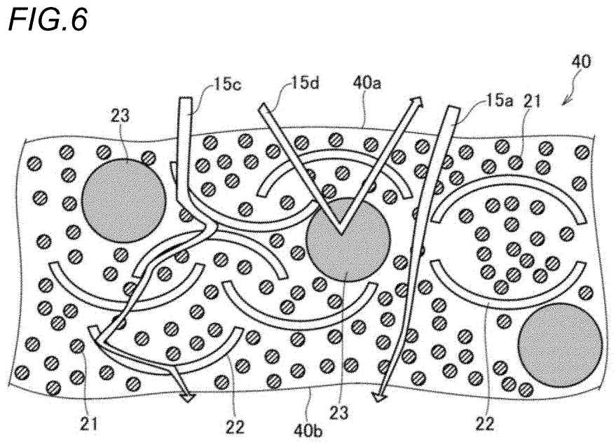

FIG. 6 is a plan view schematically showing a configuration of a heat insulation sheet for a battery pack according to a second embodiment of the present invention. In the second embodiment shown in FIG. 6, the same elements as those of the first embodiment shown in FIGS. 1 to 5 are designated by the same reference numerals, and detailed description thereof will be omitted. In addition to the first heat insulation material 21 containing the silica nanoparticle and the second heat insulation material 22 containing the plate-shaped particle containing a silica component and having a curved surface, a heat insulation sheet 40 includes a third heat insulation material 23 containing a metal oxide.

In the second embodiment configured in this way, titania is used as the third heat insulation material 23 containing a metal oxide. The metal oxide is a component having a high refractive index and diffusely reflecting light. When the battery cell 20 generates heat and a part of the heat reaches the third heat insulation material 23 by radiation from one surface 40a side of the heat insulation sheet 40, the heat is reflected by the third heat insulation material 23 (titania) as shown by an arrow 15d. Therefore, due to presence of titania, even in a high temperature range of 500° C. or higher, where influence of radiation is particularly large, it is possible to prevent heat from being transmitted to the other surface 40b of the heat insulation sheet 10.

<Details of Heat Insulation Sheet for Battery Pack>

Next, the first heat insulation material 21 and the second heat insulation material 22 constituting the heat insulation sheet 10 for battery pack will be described in detail.

(Kind of First Heat Insulation Material)

In the present invention, the silica nanoparticle is used as the first heat insulation material 21. As the silica nanoparticle, wet silica, fumed silica, aerogel, and the like can be used.

In the present invention, the silica nanoparticle is a nanometer-order silica particle having an average particle diameter of less than 1 μm, which is spherical or close to spherical.

(Average Particle Diameter of First Heat Insulation Material: 1 nm or More and 100 nm or Less)

As described above, the particle diameter of the first heat insulation material 21 may affect the heat insulation property of the heat insulation sheet 10. Therefore, when the average particle diameter of the first heat insulation material 21 is limited to a predetermined range, a higher heat insulation property can be obtained. That is, when the average particle diameter of the first heat insulation material 21 is 1 nm or more and 100 nm or less, especially in a temperature range below 500° C., convective heat transfer and conductive heat transmission of the heat in the heat insulation sheet 10 can be reduced, and the heat insulation property can be further improved.

The average particle diameter of the first heat insulation material 21 is more preferably 2 nm or more, and still more preferably 3 nm or more. The average particle diameter of the first heat insulation material 21 is more preferably 50 nm or less, and still more preferably 10 nm or less.

In the present invention, the average particle diameter is obtained by photographing the heat insulation sheet 10 with a microscope, comparing a major axis of any 10 particles with a standard scale, and taking an average value thereof. Any microscope may be used, and an SEM, a polarizing microscope, or the like can be used.

(Kind of Second Heat Insulation Material)

In the present invention, as the second heat insulation material 22, the plate-shaped particle containing a silica component and having a curved surface is used. As described above, since the second heat insulation material 22 has such a shape, the strength in the plane direction is strengthened, the shape retention property is enhanced, and it is difficult to transmit heat in the thickness direction. When a large compressive stress is applied to the heat insulation sheet 10, since the second heat insulation material 22 having the dome-shaped voids filled with the first heat insulation material 21 (the silica nanoparticle) resists the compressive stress while bending, it is possible to prevent the first heat insulation material 21 (the silica nanoparticle) having an excellent heat insulation effect from falling. As the second heat insulation material 22, at least one kind of fragment of a balloon selected from a shirasu balloon, a silica balloon, a fly ash balloon, a perlite balloon, and a glass balloon can be used.

(Orientation of Second Heat Insulation Material)

As shown in the heat insulation sheet 10 in FIG. 5, the second heat insulation material 22 is preferably oriented in the plane direction of the heat insulation sheet 10. Since the second heat insulation material 22 is the plate-shaped particle having a curved surface, when the second heat insulation material 22 is oriented, anisotropy is generated regarding heat conduction and strength. Because the second heat insulation material 22 is oriented in the plane direction, the heat insulation sheet 10 reduces the heat conduction in the thickness direction and becomes stronger in the plane direction. In the present description, the second heat insulation material 22 orienting in the plane direction of the heat insulation sheet 10 means that most of the second heat insulation material 22 is arranged in substantially the same direction, and it is not necessary that the entire second heat insulation material 22 is arranged in exactly the same direction.

A content of the silica component of the second heat insulation material 22 is not particularly limited, but is preferably, for example, 40 mass % or more with respect to a total mass of the second heat insulation material. Since silica has an irregular network structure, when silica is melted, it becomes a viscous fluid. When a content of the silica component of the second heat insulation material 22 is 40 mass % or more, a curved surface having a good shape can be obtained. The content of the silica component of the second heat insulation material 22 is preferably 90 mass % or less. When the content of the silica component of the second heat insulation material 22 is 90 mass % or less, it can be easily obtained by using a natural mineral as a raw material.

When the fragment of an inorganic balloon is used as the second heat insulation material 22, the fragment of an inorganic balloon previously crushed to a desired size may be used, or the inorganic balloon may be crushed to a desired size during manufacture of the heat insulation sheet 10. Accordingly, in the present invention, an inexpensive inorganic balloon can be used, and conventional manufacturing equipment can be used without modification. Therefore, the heat insulation sheet 10 having an excellent heat insulation property can be easily manufactured at a low cost.

(Average Particle Length of Second Heat Insulation Material: 0.1 μm or More and 100 μm or Less)

When the second heat insulation material 22 has an appropriate size, the above effect of the second heat insulation material 22 can be sufficiently obtained, and voids having an appropriate size are formed. That is, when an average particle length of the second heat insulation material 22 is 0.1 μm or more, the voids are filled with a large amount of the first heat insulation material 21, and when a compressive stress is applied from outside, the curved surface is deformed to counter the stress, the first heat insulation material 21 can be prevented from falling, and so it is preferable.

When the average particle length of the second heat insulation material 22 is 100 μm or less, a distance that one particle of the second heat insulation material 22 transmits heat can be shortened. Therefore, even if there are particles oriented in the thickness direction, no path for the conduction heat transmission is formed, and it is possible to prevent the heat insulation property from being lowered, and so it is preferable.

In the present invention, the average particle length is obtained by photographing the heat insulation sheet 10 with a microscope, comparing a major axis of any 10 particles with a standard scale, and taking an average value thereof. Any microscope may be used, and an SEM, a polarizing microscope, or the like can be used.

A radius of curvature of the second heat insulation material 22 is preferably 0.5 μm to 50 μm. When the inorganic balloon is used as the second heat insulation material 22, it is considered that a radius of the inorganic balloon corresponds to it, and the second heat insulation material 22 having a desired size can be obtained.

The radius of curvature of the second heat insulation material 22 can be measured by embedding the heat insulation sheet 10 in resin so that a cross section of the heat insulation sheet 10 can be confirmed, identifying a center of the curved surface from an enlarged image of the microscope, and comparing it with a standard scale. A kind of the microscope can be appropriately selected depending on an object, and a polarizing microscope, an SEM, or the like can be used.

(Content of First Heat Insulation Material: 10 Mass % or More and 60 Mass % or Less with Respect to Total Mass of Heat Insulation Sheet)

In the present invention, it is preferable to appropriately adjust a ratio of the first heat insulation material 21 so as to secure an appropriate heat insulation property. When the content of the first heat insulation material 21 is 10 mass % or more with respect to the total mass of the heat insulation sheet, since the first heat insulation material 21 is originally a material having a high heat insulation property against conductive heat transfer and convective heat transfer, it is possible to obtain the heat insulation sheet 10 having a high heat insulation property, and so it is preferable. Therefore, the content of the first heat insulation material 21 is preferably 10 mass % or more, more preferably 15 mass % or more, and still more preferably 20 mass % or more, with respect to the total mass of the heat insulation sheet.

When the content of the first heat insulation material 21 is 60 mass % or less with respect to the total mass of the heat insulation sheet, the silica nanoparticles are supported by other materials, and so it is preferable. Therefore, even if vibration, pressure, deformation, or the like is applied, it is possible to further prevent the silica nanoparticles from falling. Therefore, the content of the first heat insulation material 21 is preferably 60 mass % or less, more preferably 55 mass % or less, and still more preferably 50 mass % or less, with respect to the total mass of the heat insulation sheet.

(Content of Second Heat Insulation Material: 10 Mass % or More and 60 Mass % or Less with Respect to Total Mass of Heat Insulation Sheet)

In the present invention, it is preferable to appropriately adjust a ratio of the second heat insulation material 22 so as to secure appropriate heat insulation property and shape retention property. When the content of the second heat insulation material 22 is 10 mass % or more with respect to the total mass of the heat insulation sheet, the plate-shaped particles having a curved surface of the second heat insulation material 22 can wrap the first heat insulation material 21 and even if vibration, stress, or deformation is applied, it is possible to prevent from falling, and so it is preferable. Therefore, the content of the second heat insulation material 22 is preferably 10 mass % or more, more preferably 15 mass % or more, and still more preferably 20 mass % or more, with respect to the total mass of the heat insulation sheet.

When the content of the second heat insulation material 22 is 60 mass % or less with respect to the total mass of the heat insulation sheet, it is possible to sufficiently secure other heat insulation components retained in the voids, block air flow, and block convective heat transfer, and so it is preferable. Therefore, the content of the second heat insulation material 22 is preferably 60 mass % or less, more preferably 55 mass % or less, and still more preferably 50 mass % or less, with respect to the total mass of the heat insulation sheet.

In addition to the first heat insulation material 21 and the second heat insulation material 22, the heat insulation sheet 10 for battery pack may contain a third heat insulation material 23 containing a metal oxide as a component that further enhances the heat insulation effect in a high temperature range of 500° C. or higher, and may further contain components necessary for molding into a heat insulation material, such as a binding material and a colorant. Hereinafter, other components will be described in detail.

(Kind of Third Heat Insulation Material)

The heat insulation sheet 10 according to the present invention preferably contains the third heat insulation material 23 containing a metal oxide. As the metal oxide, titania, zirconia, zircon, barium titanate, zinc oxide, alumina, or the like can be used. Particularly, titania is a component having a higher refractive index than other metal oxides, and has a high effect of diffusely reflecting light in a high temperature range of 500° C. or higher. Therefore, it is most preferable to use titania.

(Average Particle Diameter of Third Heat Insulation Material: 0.1 μm or More and 50 μm or Less)

Since a particle diameter of the third heat insulation material 23 may affect an effect of reflecting heat, when the average particle diameter of the third heat insulation material 23 is limited to a predetermined range, a higher heat insulation property can be obtained.

That is, when the average particle diameter of the third heat insulation material 23 is 0.1 μm or more, it is sufficiently larger than a wavelength of light that contributes to heating. Therefore, light can be diffusely reflected efficiently. Therefore, when the third heat insulation material 23 is in a preferable existence range (mass ratio) in the present invention, radiation heat transmission of the heat in the heat insulation sheet 10 is reduced in a high temperature range of 500° C. or higher, and the heat insulation property can be further improved. When the average particle diameter of the third heat insulation material 23 is 50 μm or less, even if itis compressed, the number of contact points between the particles does not increase, it is difficult to form a path for conductive heat transfer, and influence on the heat insulation property in a normal temperature range where the conductive heat transfer is particularly dominant can be reduced.

The average particle diameter of the third heat insulation material 23 is more preferably 1 μm or more, and still more preferably 5 μm or more. The average particle diameter of the third heat insulation material 23 is more preferably 30 μm or less, and still more preferably 10 μm or less.

(Content of Third Heat Insulation Material: 5 Mass % or More and 40 Mass % or Less with Respect to Total Mass of Heat Insulation Sheet)

In the present invention, in order to improve the heat insulation property in a high temperature range of 500° C. or higher, although it is preferable that the heat insulation sheet 10 contains the third heat insulation material 23, even if an addition amount of the third heat insulation material 23 is small, the effect of reducing radiation heat transmission can be obtained. In order to obtain the effect of reducing convective heat transfer and conductive heat transfer by the first heat insulation material 21 and the second heat insulation material 22, it is preferable to increase addition amount of the first heat insulation material 21 and the second heat insulation material 22. As described above, the mass ratio of the third heat insulation material 23 affects the heat insulation property in a range from a normal temperature to a high temperature of 500° C. or higher. Therefore, in the present invention, when the heat insulation sheet 10 contains a metal oxide as the third heat insulation material 23, it is preferable to appropriately adjust the mass ratio of the third heat insulation material 23.

In the heat insulation sheet 10 of the present invention, a desirable mass ratio of the third heat insulation material 23 is 5 mass % or more with respect to the total mass of the heat insulation sheet. When the content of the third heat insulation material 23 is 5 mass % or more with respect to the total mass of the heat insulation sheet, it is considered that radiation heat transmission can be reduced particularly in a temperature range of 500° C. or higher where influence of radiation is large, and a high heat insulation property can be obtained.

The desirable mass ratio of the third heat insulation material 23 of the heat insulation sheet 10 of the present invention is 40 mass % or less with respect to the total mass of the heat insulation sheet. When the content of the third heat insulation material 23 exceeds 40 mass % with respect to the total mass of the heat insulation sheet, the first heat insulation material 21 and the second heat insulation material 22 may not achieve a sufficient effect, it becomes difficult to reduce the convective heat transfer or solid conduction of heat in the heat insulation sheet 10 in a temperature range of less than 500° C., and the heat insulation property may be reduced.

In addition to the first heat insulation material 21, the second heat insulation material 22, and preferably the third heat insulation material 23, the heat insulation sheet 10 for battery pack may further contain components necessary for molding into a heat insulation material, such as a binding material and a colorant. Hereinafter, other components will be described in detail.

(Binding Material: 10 Mass % or More and 60 Mass % or Less with Respect to Total Mass of Heat Insulation Sheet)

The heat insulation sheet 10 for battery pack according to the present invention can be formed by sintering or the like even if it does not contain a binding material, but in particular, when the heat insulation sheet 10 for battery pack contains the silica nanoparticle as the first heat insulation material 21, it is preferable to add a binding material in an appropriate content in order to maintain the shape of the heat insulation sheet 10. In the present invention, the binding material may be any material as long as it can hold the first heat insulation material 21 and the second heat insulation material 22, no matter what the form thereof is, such as a binder with adhesion, a fiber that physically entangles particles, or a heat-resistant resin that adheres by adhesive force.

As the binder, an organic binder, an inorganic binder, or the like can be used. The present invention is not particularly limited to these kinds, but as the organic binder, a polymer flocculant, an acrylic emulsion, or the like can be used, and as the inorganic binder, for example, silica sol, alumina sol, sulfate band, or the like can be used. These binders function as an adhesive when a solvent such as water is removed.

As the fiber, organic fibers, inorganic fibers, or the like can be used. The organic fibers are not particularly limited, but synthetic fibers, natural fibers, pulps, or the like can be used. The inorganic fibers are not particularly limited, but it is preferable to use alumina fiber, silica-alumina fiber, silica fiber, glass fiber, glass wool, rock wool, or the like.

Since the binding material contains a component having higher heat conductivity than the first heat insulation material 21, the second heat insulation material 22, and the like, when the binder is present in the voids formed in the heat insulation sheet 10 to such an extent that conductive heat transfer does not occur, the reduction of convective heat transfer and conductive heat transfer by the first heat insulation material 21 will be affected. Therefore, in the heat insulation sheet 10 for battery pack of the present invention, a content of the binding material is preferably 60 mass % or less, more preferably 50 mass % or less, with respect to the total mass of the heat insulation sheet. In the heat insulation sheet 10 for battery pack of the present invention, the content of the binding material is preferably 10 mass % or more, more preferably 20 mass % or more, with respect to the total mass of the heat insulation sheet.

(Average Fiber Diameter of Inorganic Fiber: 0.1 μm or More and 20 μm or Less)

The inorganic fiber is a linear or needle-shaped fiber, and contributes to improvement of mechanical strength and shape retention property against the compressive stress from the battery cells 20 of the heat insulation sheet 10.

In order to obtain such an effect, when an inorganic fiber is used as the binding material, an average fiber diameter thereof is preferably 0.1 μm or more, and more preferably 2 μm or more. However, if the inorganic fiber is too thick, since moldability and processability on the heat insulation sheet 10 may decrease, the average fiber diameter is preferably 20 μm or less, and more preferably 15 μm or less.

(Average Fiber Length of Inorganic Fiber: 0.1 mm or More and 20 mm or Less)

When an inorganic fiber is used as the binding material, the fibers are suitably entangled with each other when molded as the heat insulation sheet 10, and a sufficient surface pressure can be obtained.

In order to obtain such an effect, when an inorganic fiber is used, an average fiber length thereof is preferably 0.1 mm or more, and more preferably 0.5 mm or more. However, if the average fiber length of the inorganic fiber is too long, during preparation of a slurry solution in which the inorganic fiber is dispersed in water in a sheet forming process, the entanglement between the inorganic fibers may become too strong, and the inorganic fibers may easily accumulate non-uniformly after being formed into a sheet.

Therefore, the average fiber length of the inorganic fiber is preferably 20 mm or less, and more preferably 10 mm or less.

The fiber diameter and fiber length of the inorganic fiber can be measured by extracting the inorganic fiber from a molded sheet without breaking it by tweezers, observing the inorganic fiber with a microscope, and comparing it with a standard scale. The average fiber diameter and the average fiber length of the inorganic fiber are obtained from an average value of any 10 fibers.

(Thickness of Heat Insulation Sheet: 0.1 mm or More and 30 mm or Less)

A thickness of the heat insulation sheet 10 for battery pack according to the present invention is not particularly limited, but is preferably in a range of 0.1 mm or more and 30 mm or less. When the thickness of the heat insulation sheet 10 is within the above range, sufficient mechanical strength can be obtained and molding can be easily performed.

(Method for Manufacturing Heat Insulation Sheet for Battery Pack)

Next, a method for manufacturing the heat insulation sheet for the battery pack according to the present invention will be described in detail.

The heat insulation sheet 10 according to the present embodiment may be manufactured by molding materials for the heat insulation sheet including the first heat insulation material 21 and second heat insulation material 22 by a wet sheet forming method, a dry molding method, or a wet molding method, and may also be manufactured by an extrusion molding method. Hereinafter, a manufacturing method under a case where the heat insulation sheet 10 is obtained by each molding method will be described.

[Manufacturing Method of Heat Insulation Sheet by Wet Sheet Forming Method]

In the wet sheet forming method, first, a mixed liquid is prepared by mixing the first heat insulation material 21 and the second heat insulation material 22, and if necessary, an inorganic fiber, an organic fiber, or an organic binder, which is the binding material, in water, and stirring with a stirrer. Then, the obtained mixed liquid is poured into a molding device provided with a mesh for filtration on a bottom surface thereof, and the mixed liquid is dehydrated through the mesh to prepare a wet sheet. Then, the heat insulation sheet 10 can be obtained by heating and pressurizing the obtained wet sheet. The second heat insulation material 22 is oriented in the plane direction during the filtration and pressurizing. Before the heating and pressurizing, hot air may be aerated through the wet sheet to dry the sheet, but this aeration-drying treatment may also not be carried out, and the wet sheet may be heated and pressurized in a wet state.

[Manufacturing Method of Heat Insulation Sheet by Dry Molding Method]

In the dry molding method, first, the first heat insulation material 21 and the second heat insulation material 22, and if necessary, an inorganic fiber, an organic fiber, or an organic binder as the binding material are put into a V-type mixer or the like in a predetermined ratio. After thoroughly mixing the materials put into the mixer, the heat insulation sheet 10 can be obtained by putting the mixture into a predetermined mold and pressing the mold. During the pressing, the mold may be heated if necessary. The second heat insulation material 22 is oriented in the plane direction during the pressing.

The pressing pressure is preferably in a range of 0.98 MPa to 9.80 MPa. If the pressing pressure is less than 0.98 MPa, the obtained heat insulation sheet may not be able to maintain a strength thereof and may collapse. If the pressing pressure exceeds 9.80 MPa, workability may be lowered due to excessive compression, and a bulk density may be increased, so that the solid heat transmission may be increased and the heat insulation property may be lowered.

[Manufacturing Method of Heat Insulation Sheet by Extrusion Molding Method]

In the extrusion molding method, first, the first heat insulation material 21 and the second heat insulation material 22, and if necessary, an inorganic fiber, an organic fiber, or an organic binder, which is the binding material, are added with water and kneaded with a kneader to prepare a paste. Then, the obtained paste is extruded from a slit-shaped nozzle using an extrusion molding device and further dried to obtain the heat insulation sheet 10. As the organic binder, methyl cellulose, water-soluble cellulose ether, and the like are preferably used, but any organic binder generally used when an extrusion molding method is used can be used without particular limitation. In the extrusion molding method, the second heat insulation material 22 is oriented in an extrusion direction.

As mentioned above, in any of the manufacturing methods, when an inorganic balloon is used as the second heat insulation material 22, the fragment of the balloon previously crushed to a desired size may be used, or the balloon may be mixed and stirred together with the above materials and crushed to a desired size by adjusting intensity and time of stirring.

<Battery Pack>

As illustrated in FIG. 5, in the battery pack 100 according to the present invention, battery cells 20 are arranged so as to interpose the heat insulation sheet 10 for the battery pack, and battery cells 20 are connected in series or in parallel.

Although various embodiments have been described above with reference to the drawings, it is needless to say that the present invention is not limited to such examples. It is apparent to those skilled in the art that various changes and modifications can be conceived within the scope of the claims, and it is also understood that such variations and modifications belong to the technical scope of the present invention. In addition, constituent elements in the embodiments described above may be combined freely within a range not departing from the spirit of the present invention.

The present application is based on Japanese Patent Application No. 2019-170437 filed on Sep. 19, 2019, the contents of which are incorporated herein by reference.

### REFERENCE SIGNS LIST

10, 40: heat insulation sheet (for battery pack)
10a, 10b, 40a, 40b: surface
20: battery cell
21: first heat insulation material
22: second heat insulation material
23: third heat insulation material
30: battery case
100: battery pack

1. A heat insulation sheet for a battery pack, the heat insulation sheet being interposed between battery cells in the battery pack in which the battery cells are connected in series or in parallel, the heat insulation sheet comprising:
a first heat insulation material containing a silica nanoparticle; and
a second heat insulation material containing a plate-shaped particle containing a silica component and having a curved surface.

2. The heat insulation sheet for the battery pack according to claim 1, wherein
the second heat insulation material is oriented in a plane direction.

3. The heat insulation sheet for the battery pack according to claim 1, wherein
a content of the first heat insulation material is 10 mass % or more and 60 mass % or less with respect to a total mass of the heat insulation sheet for the battery pack.

4-14. (canceled)

15. The heat insulation sheet for the battery pack according to claim 2, wherein
a content of the first heat insulation material is 10 mass % or more and 60 mass % or less with respect to a total mass of the heat insulation sheet for the battery pack.

16. The heat insulation sheet for the battery pack according to claim 1, wherein
the first heat insulation material has an average particle diameter of 1 nm or more and 100 nm or less.

17. The heat insulation sheet for the battery pack according to claim 2, wherein
the first heat insulation material has an average particle diameter of 1 nm or more and 100 nm or less.

18. The heat insulation sheet for the battery pack according to claim 3, wherein
the first heat insulation material has an average particle diameter of 1 nm or more and 100 nm or less.

19. The heat insulation sheet for the battery pack according to claim 4, wherein
the first heat insulation material has an average particle diameter of 1 nm or more and 100 nm or less.

20. The heat insulation sheet for the battery pack according to claim 1, wherein
the plate-shaped particle is a fragment of an inorganic balloon.

21. The heat insulation sheet for the battery pack according to claim 20, wherein
the inorganic balloon is at least one kind of an inorganic balloon selected from a shirasu balloon, a silica balloon, a fly ash balloon, a perlite balloon, and a glass balloon.

22. The heat insulation sheet for the battery pack according to claim 1, wherein
the second heat insulation material is the plate-shaped particle having an average particle length of 0.1 μm or more and 100 μm or less.

23. The heat insulation sheet for the battery pack according to claim 1, wherein
a content of the second heat insulation material is 10 mass % or more and 60 mass % or less with respect to the total mass of the heat insulation sheet for the battery pack.

24. The heat insulation sheet for the battery pack according to claim 1, further comprising:
a third heat insulation material containing a metal oxide.

25. The heat insulation sheet for the battery pack according to claim 24, wherein
the metal oxide is at least one kind of a particle selected from titania, zirconia, zircon, barium titanate, zinc oxide, and alumina.

26. The heat insulation sheet for the battery pack according to claim 24, wherein
the metal oxide has an average particle diameter of 0.1 μm or more and 50 μm or less.

27. The heat insulation sheet for the battery pack according to claim 24, wherein
a content of the third heat insulation material is 5 mass % or more and 40 mass % or less with respect to a total mass of the heat insulation sheet for the battery pack.

28. The heat insulation sheet for the battery pack according to claim 1, further comprising:
a binding material which contains at least one kind selected from an inorganic fiber, a binder, and a heat resistant resin, wherein
a content of the binding material is 10 mass % or more and 60 mass % or less with respect to the total mass of the heat insulation sheet.

29. A battery pack, wherein
battery cells are arranged so as to interpose the heat insulation sheet for the battery pack according to claim 1, and the battery cells are connected in series or in parallel.
